(19) United States
(12) Patent Application Publication
(10) Pub. No.: US 2008/0282299 A1
(43) Pub. Date: Nov. 13, 2008

(54) Method and Apparatus for Delivering Consumer Entertainment Services Accessed Over an Ip Network

(76) Inventors: Peter Koat, Surrey (CA); Mark Sauer, Vancouver (CA); Qiang Wang, Burnaby (CA)

Correspondence Address: MORRISON & FOERSTER LLP, 12531 HIGH BLUFF DRIVE, SUITE 100, SAN DIEGO, CA, 92130-2040, US

(21) Appl. No.: 11/578,625

(22) PCT Filed: Apr. 18, 2005
(86) PCT No.: PCT/CA05/00583

§ 371 Date: Nov. 2, 2007

(30) Foreign Application Priority Data
Apr. 16, 2004 (CA) 2464789

(51) Int. Cl. H04N 7/173

(52) U.S. Cl. 725/93

(57) ABSTRACT

The present invention provides IP-centric, multi-channel, time-shifted and real-time telecommunications services to a plurality of system users. The system can capture both digital and analog multi-channel feeds and, through a cross-connect layer, can convert the signals to a digital format and subsequently send them to an encoder to be compressed. The encoding process can use a firmware upgradeable software developed to decrease data bitrates while retaining quality of the information at a desired level. The encoded, compressed signals may either be stored on a data-on-demand server for later viewing services, such as television/video-on-demand or audio-on-demand, or may be streamed directly to system users using a Media Streaming Subsystem (MSS). The MSS can be responsive to a system user request and operative to forward a selected stream of compressed digital data to the system user via a gateway means. The system can include a System Controller that can provide management and control of the system components and services provided by the system. The gateway means is able to receive compressed digital data from the Media Streaming Subsystem and transmit that data to a system user sending a request over a communication network. A cable modem, DSL modem or other appropriate interface can be located at each system user's location, thereby providing a means for sending multiple signal sources to a system user's Local Area Network (LAN) to which the User Computing Device(s) (UCD) of a system user are connected. The UCD receives the compressed data from the gateway means, subsequently decodes this compressed data and presents this decompressed information to the system user via a presentation system which may or may not be integrated into the UCD, thereby providing the requested entertainment services to the system user.

### FIELD OF THE INVENTION

The present invention pertains to a system for providing consumer entertainment services and in particular to a system and method for providing video and audio data over broadband wide area networks.

### BACKGROUND

Consumer entertainment services, including video-on-demand (VOD) and personal video recorder (PVR) services can be delivered using conventional communication system architectures. In conventional digital cable systems, a channel is dedicated to the user for the duration of the video. VOD services that attempt to emulate the display of a digital versatile/video disk (DVD) are delivered from centralized video servers that are large, super-computer style processing machines. These machines are typically located at a metro services delivery center supported on a cable multiple service operator's (MSO) metropolitan area network. The consumer selects the video from a menu and the video is streamed out from a video server. The video server encodes the video on the fly and streams out the content to a set-top box that decodes it on the fly; no caching or local storage is required at the set-top box. In such centralized video server architecture, the number of simultaneous users is constrained by the capacity of the video server. This solution can be quite expensive and difficult to scale. “Juke-box” style DVD servers suffer from similar performance and scalability problems.

Internet Protocol (IP) streaming can be used to avoid dedicating channel bandwidth to each user. IP streaming has been designed to overcome the shortcomings of typical IP networks by providing codecs that are friendlier to packet loss and can tolerate multiple available bit-rates. Thus, the same video stream can continue to play, albeit at a lower quality, should the network suddenly get congested.

Personal video recorder services, for example TiVo and Replay TV, allow consumers to record selected programs on local storage and play them later, at their convenience. Such services are popular with consumers as they replace the sequentially-accessible and cumbersome videotapes with randomly-accessible hard drives. Such hard-disk enabled devices bring superior recording and replay capabilities, such as instant fast-forward and recording of multiple programs simultaneously.

However, the capabilities offered by such PVRs can come at a significant price. Although hard drive prices have dropped significantly, they still make up a large portion of the cost of a personal video recorder. Volume production and other logistics have kept the median price of hard drives at an optimal level for personal computers, for example, but relatively high for low-cost consumer devices like, for example, PVRs. Hard drives have a mean time between failure (MTBF) of approximately 300,000 hours, or around thirty years. As the number of hard drives deployed goes up, so does the frequency of failure. For example, for a customer base of 30,000 users, the service provider may be replacing about 100 hard drives every month. Therefore, from a service provider perspective, the frequency and cost of servicing customer premise equipment (CPE) goes up with the number of users. Furthermore, additional power and cooling requirements make the reliability of a hard disk enabled device significantly lower than the same device without a hard drive.

While consumers and service providers face the above issues, content providers face other issues, including a serious risk of piracy. Digitally recorded content can easily be shared over high-capacity networks in addition to being written to writable CDs, DVDs and other storage media.

Having particular regard to typical DVD players, they operate at a minimum 8 times (150 KBps) speed, producing 8 times 150 KBps times 8 bits/byte=9.6 Mbps with a latency of <100 ms, for example. DVD players require predictable throughput in a burst-mode (e.g., constant 128 KB block fetches every 100 milliseconds).

Current video servers employ powerful processors, or a network of powerful processors, to serve video content. The number of simultaneous users they can support is constrained by the capacity of the video server. Typical video servers encode their content on the fly, for example for Real Media or Windows Media formats, and set-top-boxes decode on the fly.

Video-on-demand services have been known in hotel television systems for several years. Video-on-demand services allow users to select programs to view and have the video and audio data of those programs transmitted to their television sets. Examples of such systems include: U.S. Pat. No. 6,057,832 disclosing a video-on-demand system with a fast play and a regular play mode; U.S. Pat. No. 6,055,560 disclosing an interactive video-on-demand system that supports functions normally only found on a VCR such as rewind, stop, fast forward, etc.; U.S. Pat. No. 6,055,314 which discloses a system for secure purchase and delivery of video content programs over distribution networks and DVDs involving downloading of decryption keys from the video source when a program is ordered and paid for; U.S. Pat. No. 6,049,823 disclosing an interactive video-on-demand to deliver interactive multimedia services to a community of users through a LAN or TV over an interactive TV channel; U.S. Pat. No. 6,025,868 disclosing a pay-per-play system including a high-capacity storage medium; U.S. Pat. No. 6,020,912 disclosing a video-on-demand system having a server station and a user station with the server station being able to transmit a requested video program in normal, fast forward, slow, rewind or pause modes; U.S. Pat. No. 5,945,987 teaching an interactive video-on-demand network system that allows users to group together trailers to review at their own speed and then order the program directly from the trailer; U.S. Pat. No. 5,935,206 teaching a server that provides access to digital video movies for viewing on demand using a bandwidth allocation scheme that compares the number of requests for a program to a threshold and then, under some circumstances of high demand makes another copy of the video movie on another disk where the original disk does not have the bandwidth to serve the movie to all requesters; U.S. Pat. No. 5,926,205 teaching a video-on-demand system that provides access to a video program by partitioning the program into an ordered sequence of N segments and provides subscribers concurrent access to each of the N segments; U.S. Pat. No. 5,802,283 teaching a public switched telephone network for providing information from multimedia information servers to individual telephone subscribers via a central office that interfaces to the multimedia server(s) and receives subscriber requests and including a gateway for conveying routing data and a switch for routing the multimedia data from the server to the requesting subscriber over first, second and third signal channels of an ADSL link to the subscriber.

IP-centric, multi-channel, time-shifted and real-time telecommunication services designed to receive requests from subscribers for programs or services such as high speed Internet access or access to other broadband services has not yet completed development. Such systems receive upstream requests and deliver requested programs with associated video, audio and other data, as well as bidirectional delivery of Internet Protocol packets from LAN or WAN sources coupled to the head-end bidirectional delivery of data packets to and from T1, T3 or other high speed lines of a broadband network. Therefore there is a need for an IP-centric, multi-channel, time-shifted and real-time telecommunications services system that can deliver a plurality of services to users in one integrated system with greater efficiency and better features.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method and apparatus for delivering consumer media services accessed over an IP network. In accordance with an aspect of the present invention, there is provided a system for providing a plurality of system users IP-centric, multi-channel, time-shifted and real-time telecommunications services including live television, television-on-demand, video-on-demand, streaming audio, audio-on-demand, said system comprising: a compressed data creation subsystem for receiving multiple data signal streams each having one of several industry standard communication formats, and for converting the incoming data signal streams into compressed digital data, said compressed digital data being created using a predetermined compression scheme; a storage means for storing selected compressed digital data and permitting stored compressed digital data to be retrieved therefrom; a media streaming subsystem for receiving and forwarding streams of compressed digital data, said media streaming subsystem being responsive to a user request and operative to forward a selected stream of compressed digital data from either the compressed data creation subsystem or the storage means to a gateway means; a gateway means for receiving said compressed digital data from the media streaming subsystem and preparing said compressed digital data for transmission over a broadband communication network to a user sending the user request; and a user computing device, connected to the broadband communication network, for receiving the selected stream of compressed digital data and the user computing device decompressing and presenting said selected stream of compressed digital to the system user.

In accordance with another aspect of the present invention, there is provided a method for providing a plurality of system user IP-centric, multi-channel, time-shifted and real-time telecommunications services including live television, television-on-demand, video-on-demand, streaming audio, audio-on-demand, said method comprising: receiving multiple incoming data signal streams each having one of several industry standard communication formats and converting the incoming data signal streams into compressed digital data using a predetermined compression scheme; storing selected compressed digital data; selecting user requested compressed digital data from the compressed digital data and the selected compressed digital data in response to a user request and forwarding the user requested compressed digital data to a gateway means; receiving the user requested compressed digital data in the gateway means and preparing the user requested compressed digital data for transmission over a broadband communication network to a user computing device sending the user request; and receiving the user requested compressed digital data by the user computing device and decompressing and displaying the user requested compressed digital data by means of the user computing device.

### BRIEF DESCRIPTION OF THE FIGURES

FIG. 1 is a schematic system overview according to one embodiment of the present invention.

FIG. 2 is a schematic view of the system architecture according to one embodiment of the present invention.

FIG. 3 is a schematic view of the head-end portion of the system architecture illustrated in FIG. 2.

FIG. 4 is a schematic view of the transportation network of the system architecture illustrated in FIG. 2.

FIG. 5 is a schematic view of the home network of the system architecture illustrated in FIG. 2.

FIG. 6 is a block diagram of the functional elements of a set-top box according to one embodiment of the present invention.

FIG. 7 is a block diagram of the software elements integrated into a set-top box according to one embodiment of the present invention.

FIG. 8 is a block diagram illustrating interconnectivity between multiple modules and elements for system control according to one embodiment of the present invention.

FIG. 9 illustrates the program flow control of the encoding/transcoding system according to one embodiment of the present invention.

FIG. 10 illustrates a encoding/transcoding system method according to one embodiment of the present invention.

FIG. 11 illustrates a encoding/transcoding system method according to another embodiment of the present invention.

FIG. 12 illustrates a encoding/transcoding system method according to another embodiment of the present invention.

### DETAILED DESCRIPTION OF THE INVENTION

### Definitions

The term “telecommunications services” is used to define a variety of services including live television, time-shifted television programming available on demand, video-on-demand, near video-on-demand, streaming audio, audio-on-demand, broadband Internet access, and other broadband services as would be readily understood by a worker skilled in the art.

The term “encoder” is used to define a computing means that is able to encode or transcode data into a predetermined format.

The term “computing means” is used to define a computing device capable of performing a predetermined set of functions that are associated with the computing means, for example a computing means can be a microchip, microprocessor, or other computing means as would be readily understood by a worker skilled in the art.

The term “User Computing Device” (UCD) is used to define Set-top Boxes (STBs), digital phones, personal computers, digital VCRs, personal digital assistants (PDAs) or other like devices capable of receiving information from a broadband communications network, as would be readily understood by a worker skilled in the art.

Unless defined otherwise, all technical and scientific terms used herein have the same meaning as commonly understood by one of ordinary skill in the art to which this invention belongs.

The present invention provides IP-centric, multi-channel, time-shifted and real-time telecommunications services to a plurality of system users. Such telecommunication services can include live television, television-on-demand, video-on-demand, streaming audio, audio-on-demand, broadband Internet access, and other broadband services. The delivery of media services can typically be referred to as the triple-play: video, voice and data. The system can capture both digital and analog multi-channel feeds and, through a cross-connect layer, can convert the signals to a digital format and subsequently send them to an encoder to be compressed. The encoding process can use a firmware upgradeable software developed to decrease data bitrates while retaining quality of the information at a desired level. The encoded, compressed signals may either be stored on a data-on-demand server for later viewing services, such as television/video-on-demand or audio-on-demand, or may be streamed directly to system users using a Media Streaming Subsystem (MSS). The MSS can be responsive to a system user request and operative to forward a selected stream of compressed digital data to the system user via a gateway means. The system can include a System Controller that can provide management and control of the system components and services provided by the system. The gateway means is able to receive compressed digital data from the Media Streaming Subsystem and transmit that data to a system user sending a request over a communication network, wherein this communication network can include, for example, a Digital Subscriber Line (DSL), Hybrid Fibre-Coax (HFC), wireless Internet, or other communication network. A cable modem, DSL modem or other appropriate interface can be located at each system user's location, thereby providing a means for sending multiple signal sources to a system user's Local Area Network (LAN) to which the User Computing Device(s) (UCD) of a system user are connected. The UCD receives the compressed data from the gateway means, subsequently decodes this compressed data and presents this decompressed information to the system user via a presentation system which may or may not be integrated into the UCD, thereby providing the requested entertainment services to the system user.

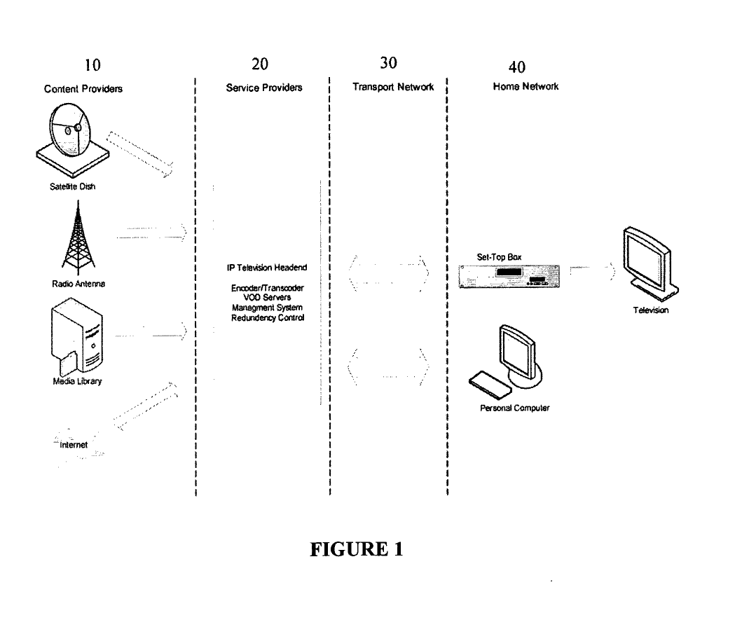

FIG. 1 is an overview of the functional architecture of one embodiment of the present invention. The content providers 10 provide the content to the system and the service provider 20 prepares the content for transmission over a transport network 30 to the house network 40 wherein the content is subsequently displayed to the user.

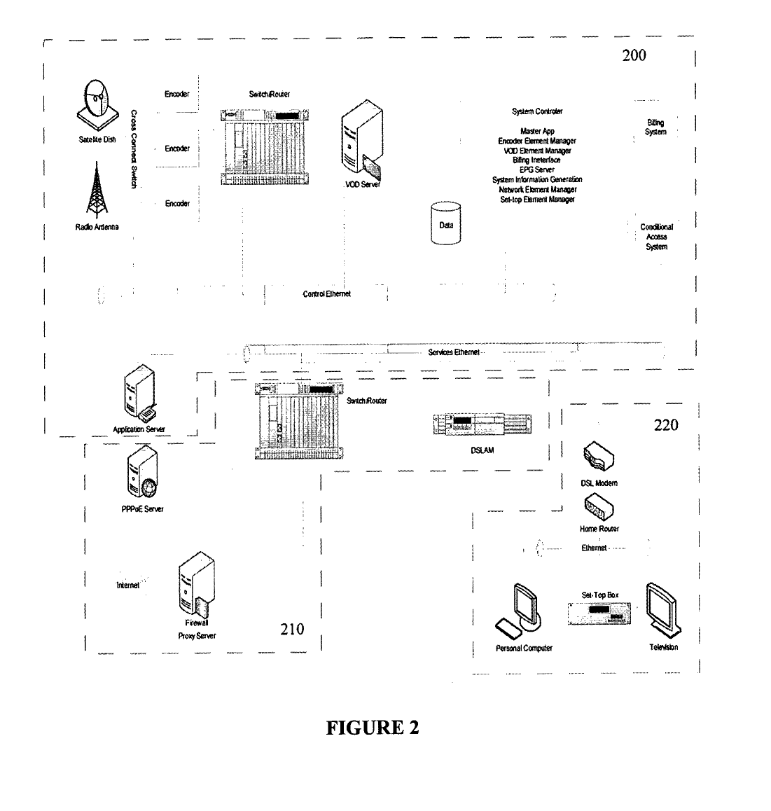

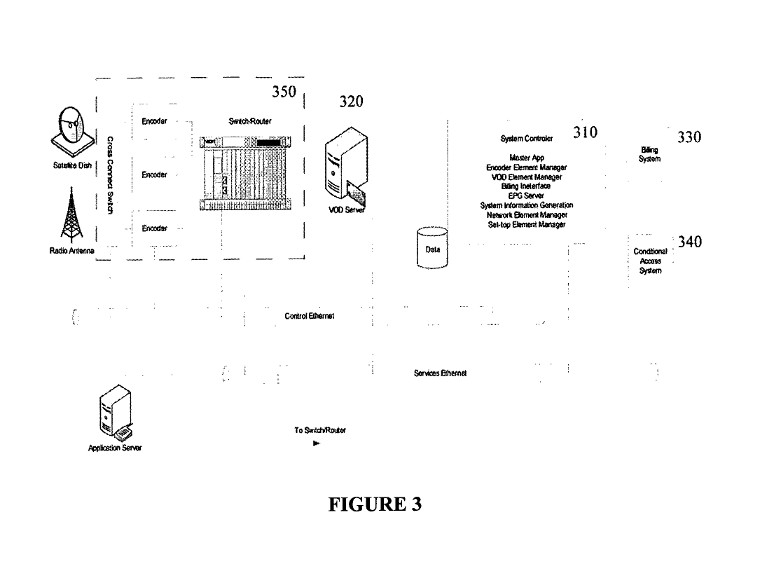

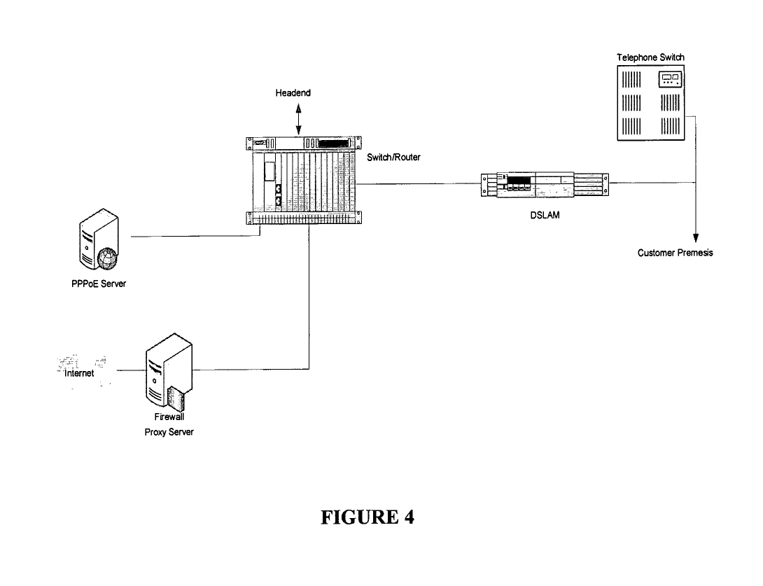

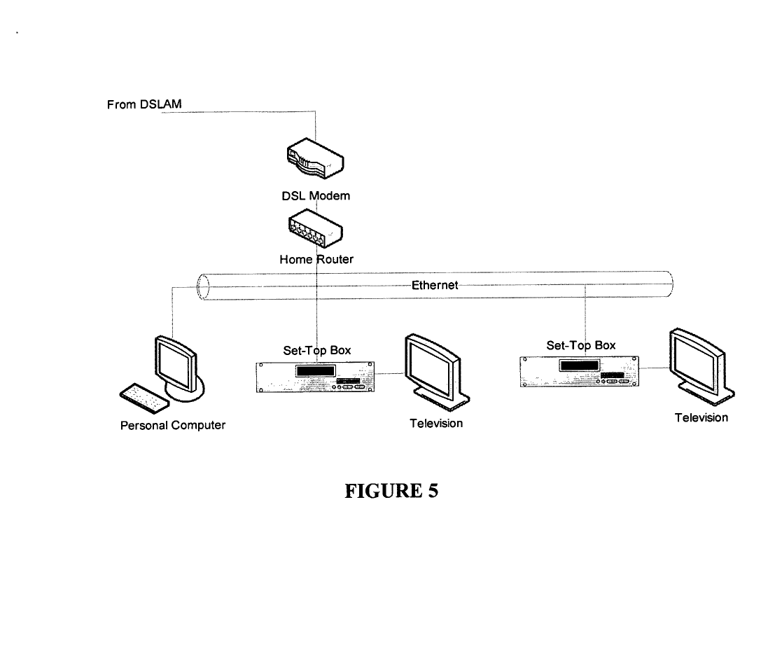

FIG. 2 illustrates the system architecture of one embodiment of the present invention. The system comprises a head end 200 enabling the collection and encoding of the signals, the transportation network 210 enabling the transmission of the information from the head end to a user, and the home network 220 enabling a user to decode the signals from the head end for subsequent presentation to the user. FIG. 3 illustrates the various components of the head end including the system controller 310, video on demand (VOD) server 320, billing system 330, the condition access system (CAS) 340 and the encoding/transcoding system 350. The encoding/transcoding system forms a portion of the compressed data creation subsystem. FIG. 4 illustrates the various components of the transportation network for broadcasting media over an IP network, wherein this transport system forms a portion of the media streaming subsystem. FIG. 5 illustrates the home network for a DSL based IP connectivity. The home network illustrates a personal computer (PC) and a set-top box (STB) sharing an Internet connection via a home router, wherein the personal computer and a set-top box are examples of user computing devices.

In one embodiment, the present invention the Compressed Data Creation Subsystem (CDCS) receives multiple data signal streams and converts the incoming data signal streams into compressed digital data using Dynamic Encoder Allocation (DEA). Rather than having dedicated hardware encoders for particular streams of data, system resources can be improved by dynamically routing data to less active non-dedicated hardware encoders. For example, if a sequence of frames of video is complex, it can be divided and routed to multiple hardware encoders to significantly reduce compression time. In turn, further data can be routed to less active hardware encoders that may have compressed less complicated data and are free to take on more data. In one embodiment, for full redundancy of encoders, which is typically required by most commercial applications with critical fault tolerance, the DEA requires at least one standby encoder per dedicated encoder.

In one embodiment, the present invention comprises a set-top box (STB) that is able to decode transmitted compressed data and output a signal to a display device, such as a television and/or audio receiver. The STB can include a polling/interrupt protocol enabling IP communication in the STB with a multi-processor coupled implementation comprising a digital signal processor (DSP) and a Central Processing Unit (CPU). This coupled implementation of a DSP and CPU can provide for an increase in productivity of the DSP, as the operating system and other applications such as an Internet browser can reside on the CPU. This coupled implementation can overcome numerous limitations of having only a DSP by allowing increased functionality through a larger instruction set, and a more flexible environment with a wide variety of software applications. The set-top box can be connected to a high-speed, quality-of-service (QoS) enabled communications network providing access to the gateway. The polling/interrupt protocol can enable unique communication between a DSP and an Interprocess Communication/Remote Procedure Call (IPC/RPC) stack.

In one embodiment, all system components and subsystems are capable of reconfiguring the resident operating system and application software with software that is downloaded via the network. This capability enables the system operator to upgrade system components and subsystems, including set-top-boxes, to a new software version via the network. In this embodiment, since both the STB and encoder software can be upgradable, the system may prevent malicious boxes from connecting to the networks. For example, all firmware upgrades can be validated before the update, otherwise it may be possible to develop a worm or virus that could eventually disrupt the entire network.

In one embodiment, the system can employ an encryption method that facilitates verification and source identification of the flash software upgrade. Each STB on the network can be monitored so they have the latest firmware. In order to motivate people to upgrade their STB, for example for those who filter out upgrade requests, the system can upgrade the codec, if using a proprietary codec, for both encode and decode such that old firmware releases will be rendered non-functional.

In one embodiment, the Media Streaming Subsystem can respond to system user inputs by forwarding compressed digital data in real time, wherein this compressed digital data represents a real time program received from the Compressed Data Creation Subsystem (CDCS) which itself is receiving the program data stream via satellite, cable or other sources. Alternatively, the MSS may respond to a system user's input by retrieving the requested data file from the system's storage unit, for example a Data on Demand (DOD) server or a Video on Demand (VOD) server and subsequently transmitting it to the system user. A server in the CDCS may manage the data creation for the streaming of the data feed. The real time data may be channeled to the storage unit and the MSS through a switch. In a more complex system, a plurality of switches can be used with a plurality of streaming media servers and storage units. The switches may, for example, be fibre channel switches. Alternatively, the switches may be Ultra SCSI, Serial-ATA (SATA), or SATA/II switches. For example, Small Computer System Interface (SCSI) is a set of evolving ANSI standard electronic interfaces that allow personal computers to communicate with peripheral hardware such as disk drives, tape drives, CD-ROM drives, printers, and scanners faster and more flexibly than previous interfaces. Serial ATA is a faster, flexible, scalable and enhanced replacement for Parallel ATA, with SATA/II providing additional switching logic. The Media Streaming Subsystem can manage the user requests by retrieving the requested data from a Data-on-Demand Server or from the Compressed Data Creation Subsystem, encoding the data based on a predetermined codec, and transmitting the encoded data to the system user through the broadband communication channels.

### Compressed Data Creation Subsystem

The Compressed Data Creation Subsystem (CDCS) provides a means for receiving a plurality of data signal streams and converting these streams into compressed digital data for subsequent storage in the storage means or for subsequent transmission to a system user over an IP based broadband communication system.

Data streams received by the CDCS can comprise sources such as digital and analog satellite signals, as well as off-air television feeds or other sources as would be readily understood by a worker skilled in the art. Appropriate digital satellite receivers, analog satellite receivers, demodulators, etc. can receive the signals and may connect to a cross-connect layer of the CDCS. For digital signals, for example, the connection between the digital receiver(s) and the cross-connect layer can be made through a Digital Video Broadcasting Asynchronous Serial Interface (DVB-ASI), which provides simple transport and interconnection of, for example, MPEG-2 streams between the equipment. The DVB-ASI channels can have the capabilities of transporting MPEG Single Program Transport Streams (SPTS) or Multi-Program Transport Streams (MPTS), each with a different data rate. For analog signals, for example, the connection between the receiver or demodulator and the cross-connect layer can be made using a Serial Digital Interface (SDI) which can transport both composite and component digital video. The cross-connect layer can transfer a plurality of channels to an Encoder Subsystem. It will be understood by those skilled in the art that the architecture of the CDCS is designed to be scalable, so that any increase in the number of the inputs may be easily absorbed by the system.

The information flow from the CDCS can be directed to at least two possible destinations. One destination may be the storage means, wherein the incoming programming data may be stored for future retrieval and use. Additionally, the incoming data may be directed to the gateway means and routed to system users that requested real-time programming, for example a real-time news broadcast. Alternatively, system user requests for previously stored programming can be processed by the Media Streaming Subsystem, which can facilitate the request through a Data-on-Demand (DOD) server that is associated therewith or with the storage means. Such requests can be processed and managed in a time efficient manner wherein the Media Streaming Subsystem can locate the requested programs, retrieves the programs and forwards them to the gateway means to be transmitted to the requesting system user, thereby enabling “real-time” display of the program by the system.

The Encoder Subsystem comprises two or more encoders that are able to compress the data using a predetermined compression scheme. The codec and software used to compress the data can be fully upgradeable and not hardwired into the encoder chips. The Encoder Element Manager (EEM), which may be a separate dedicated CPU in the System Controller, can be used to control the data flow between the cross-connect layer and the encoder chips. The output from the encoders can be either at a constant bit rate, or a variable bit rate with specified maximum thresholds, as determined by the software and codec being used at any given time. The encoders can receive normal base band audio/video to be encoded, or already compressed audio/video streams to be transcoded using the system's associated codec. Each encoder may be assigned a unique Unicast or Multicast IP address by the Encoder Element Manager. The encoders can pass the data on to the Media Streaming Subsystem, which can determine whether or not the data is to be stored before passing the information on to the gateway means. In one embodiment, the encoded data may be formatted into IP-based data packets suitable for transmission over a broadband network such as the Internet, for example, prior to storage wherein the digitized, encoded and formatted IP-based data packets can be indexed by the Media Streaming Subsystem and stored in large capacity storage units.

In one embodiment of the present invention the Compressed Data Creation Subsystem can receive multiple data signal streams and convert the incoming data signal streams into compressed digital data using Dynamic Encoder Allocation (DEA). Rather than having dedicated hardware encoders for particular streams of data, system resources can be improved by dynamically routing data to less active non-dedicated hardware encoders. For example, if a sequence of frames of video is quite complex, then it can be divided and routed to multiple hardware encoders to significantly reduce compression time. In turn, further data can be routed to less active hardware encoders that may have compressed less complicated data and are free to take on more data. In one embodiment, for full redundancy of encoders, which is typically required by most commercial applications with critical fault tolerance, at least one standby encoder is provided per dedicated encoder.

To further pipeline the encoding process, in one embodiment each hardware encoder can comprise multiple Digital Signal Processors (DSPs) coupled with a Central Processing Unit (CPU). The master application, running on the CPU, can manage the flow of raw video units. In one embodiment, the video units are composed of 1 second durations of video. Each DSP can be responsible for encoding a video unit and sending back the compressed result to the master application; wherein the encoded video units are in turn, sorted, wrapped in a system stream and then transmitted to the Media Streaming Server. The master application can monitor the DSPs with which it is coupled and can improve system resources by dynamically routing data units to the DSPs that will become free first, thus pipelining the encoding process. In addition, if there is a problem with one of the DSPs, the EEM can ensure that the damaged DSP will not be used, thereby enabling “graceful” failure. This process can be a scalable solution, as more DSPs can be added to the hardware encoders to increase the overall speed of encoding numerous data signals. When the data from a signal to be encoded is more complex, for example when encoding a video signal that is at a very high resolution, the signal can be accommodated by adding more DSPs to the system.

In one embodiment, each DSP can independently have the ability to adjust the complexity of the encode and the bit rates based on encoding statistics by using a Complexity Throttle and Bitrate Throttle, respectively. In order to ensure full frame rate encoding the DSP can be allocated a certain time period to encode a video unit, based on the duration of the unit, the natural frame rate and the number of DSPs encoding in the system. While encoding a video unit, the DSP can adjust the complexity of the process, using a function, for example a linear function, to either a quicker less efficient mode or restore to a natural high efficiency mode. As the encoding is simplified, the bitrate will likely increase. The DSP can also monitor the bitrate of the encode process and ensure that a bitrate never exceeds a threshold set by the master application, wherein this is termed the Bitrate Throttle. Hence, as the less complex mode is chosen, the bitrate throttle will force the codec to lower the quality, which in turn makes the content easier to encode. The Complexity Throttle and Bitrate Throttle (CTBT) have a symbiotic relationship to ensure that the bitrate and complexity of the clip never degrade below an acceptable level. Combined with the DEA and the CTBT, a hardware encoder can seamlessly support encoding of signals more complex than originally designed for. In one embodiment, each DSP in an encoder box could be allocated a television channel, whereby the CTBT would act like a StatMUX, sharing an overall bitrate for each VBR channel.

The encoders can send back status data to the Encoder Element Manager, which may be a separate CPU dedicated to provisioning the hardware encoders, monitoring the hardware encoders for failures, evaluating the activity of individual hardware encoders, and managing the data flow between them. Specifically, if there is ever a problem with one of the hardware encoders, data can be shifted by use of the Encoder Element Manager to other hardware encoders or backup hardware encoders, thereby minimizing signal interruption.

Having regard to the encoding process, a digital format of a video/TV signal can be created using a codec, short form of “encoding and decoding”. When an analog video signal is sent through a codec, the signal is encoded (transformed) into a digital format. In a digital video signal, for example, every frame is about 2.5 Mbits in size which corresponds to about a 75 Mbits per second (Mbps) bitrate based on 30 frames per second to limit or eliminate visible flicker. Accordingly, a codec can be designed to also compress the signal to enable video streaming at lower bit rates. The quality of the digital signal depends on what codec is used. MPEG-2, for example, which is used for DVDs, is a lossy codec, data is discarded and one can never retrieve the original uncompressed signal after encoding. This codec removes as much redundant information as possible, such as reducing redundant data that describes motion. To maintain a high quality of the signal, it necessitates that a high bitrate be maintained. Alternately, HuffYUV is a lossless codec which compresses video data without having any reduction in quality. HuffYUV, however, is only able to obtain a compression of approximately 2:1 to 3:1.

In general, codecs attempt to lower the bitrate by using a selected compression/decompression scheme. They all use what is often referred to as “key frames” or “intra frames” (I-Frames) and “inter frames”, which are often comprised of “predictive frames” (P-frames) and “bi-directional frames” (B-frames). I-frames are frames that contain all image data to produce a complete picture. Both P-frames and B-frames are dependent on I-frames in order to be displayed. P-frames are frames that are built from the previous frame (which could be either another P-frame, an I-frame or B-frame), and they store only the changes between the two frames. B-frames are similar to P-frames, except that they can be built from a future frame rather than a previous frame, or from a combination of both a previous frame and a future frame. Typically, B-frames built from two frames can offer substantial improvements in file size over P-frames. As B-frames are dependent on “future” frames, they are often not used in encoding live video.

To lower the bit rate, a codec typically begins by sending an I-frame that contains all image data, and then sending inter frames, usually P-frames. The inter frames contain only the changes in the image data contained since the I-frame. Thus, a digital video stream starts with an I-frame and then can, for example, contain only P-frames until the next I-frame is sent. A first I-frame contains all the data for a particular image. Thereafter, the stream may comprise a plurality of P-frames, each of which contain data reflecting changes made in the image since the I-frame. When the image has changed by a certain amount, another I-frame can be provided to contain all the image data of the changed image.

For example, two frames can each contain all image data of an image (200 Kb). The difference between the frames is then determined to create a P-frame at 50 Kb. By sending just the changes from one frame to another, the bitrate needed to transmit the video stream can be significantly reduced. By minimizing the number of I-frames in the data stream, the bit rate can be further reduced. There are two principal procedures for deciding how often to provide an I-frame in the video stream, namely, i) a particular interval can be specified (e.g., every 30th frame will be an I-frame); and ii) natural I-frames can be used, wherein an algorithm can calculate the difference from one frame to another and can decide if an I-frame is required. Natural I-frames often occur when an image changes completely, for example, when switching from one camera to another or scene changes in a movie.

Switching from a first digital video input stream to a second digital video input stream typically must be done on an I-frame of the second video stream since only an I-frame contains all image data of an image. In one embodiment of the present invention, an I-frame is provided that is available in less than one second, so that switching can be accomplished essentially whenever desired.

In a slightly more complicated system, each video stream can have a ‘natural I-frame’ encode coupled with an I-frame only channel. When a user requests a channel change, the UCD can connect to an I-frame channel, decode the frame and then connect to the ‘natural I-frame’ channel. If the I-frame was a lossless encode of the P frames, there would be no visible artefacts; however, if the I-frame was a lossy encode of the P frame, the difference, which would typically be negligible, would only propagate until the next natural I frame occurred. This system would enable instantaneous channel changes and would offer better compression results than having fixed I-frames every unit interval. In order to prevent bandwidth overload in rapid channel changes, it would be advantageous if all I-frame channels are synchronized and only have 1 or 2 frames every second, such that the I-frame channel would substantially never exceed the threshold bitrate of the system.

### Media Streaming Subsystem

The Media Streaming Subsystem provides a means for receiving and forwarding streams of compressed digital information to a system user, wherein these actions can be performed based on a system user request for the specific compressed digital information.

The Media Streaming Subsystem receives encoded streaming program data from the Compressed Data Creation Subsystem. The streaming program data can be packetized and prepared for transmission by the Media Streaming Subsystem. In an alternative embodiment, the IP packetization of the encoded signal can be performed by the Compressed Data Creation Subsystem. The data files can be indexed and stored in the storage device, thereby available for quick retrieval. The Media Streaming Subsystem may receive a request for a specific file from an inputted selection by a system user. The Media Streaming Subsystem can retrieve the requested data either from the storage device or from the Compressed Data Creation Subsystem and sends the file to the gateway means for transmission to the system user.

The Media Streaming Subsystem can retrieve data packets corresponding to a program requested by a system user in an efficient manner. In one embodiment of the present invention, the system user may be located anywhere within the network and may access the data using any access device that is broadband enabled. The Media Streaming Subsystem can communicate with other modules as required via, for example, an Ultra SCSI/fibre channel I/O module.

Having regard to changing compressed data feeds as requested by a system user, the Media Streaming Subsystem can ensure a maximum one second latency between the channel/stream changes by a system user by encoding at least one I-frame every second. For example, when a system user switches to a new channel, the new input can be displayed in less than one second.

As an example, assume that there are 100 video input streams and one is currently being broadcast to a particular system user. The other 99 streams are also being encoded by the system, with an I-frame for each stream occurring at least once every second. When a system user switches from one stream to another, there will be a maximum delay of one second of video data before another I-frame is available to be displayed to the system user.

In an alternate embodiment, having regard to changing compressed data feeds as requested by a system user, the Media Streaming Subsystem can include a plurality of buffers for temporarily storing input streams from video sources. The incoming streams comprise an I-frame and a plurality of P-frames. The data from the I-frame can be buffered. A number of other buffer locations can each store the I-frame data from the same I-frame and, in addition, store the P-frame data from a corresponding sequential P-frame. Accordingly, each buffer location contains all the data of a particular image frame (either the I-frame data by itself or the data of the most recent I-frame super-imposed on or combined with all changes to the I-frame). By using the buffer, switching from one video stream to another video stream can be accomplished at any time rather than only at an I-frame of the actual incoming video stream. Accordingly, switching can be accomplished with substantially no loss in the quality of the data. In particular, when an operator switches to the video stream from a source from another input stream, the first frame can be from the buffer and all subsequent frames can be from the actual incoming video stream from the source. Because each buffered frame contains the most recent I-frame and any changes, therefore switching can be made at any time and it may not be necessary to wait for the next I-frame.

As an example of the above alternate embodiment for providing low latency between channel changes, assume that there are four video input streams and one is to be broadcast to an audience. The other three are buffered and updated in real time. The first I-frame from each the “waiting” video stream is taken, and every bit that is coming in the streams is compared with the one in the buffered frame, for the respective stream. If it is the same, (i.e. not changed), it is discarded. If it differs from the one in the buffered frame, the old bit is replaced with the new bit. Accordingly, there is always an updated frame ready for switching. At the moment of a switch, the buffered frame is caused to be the first frame of the switched video stream, and the remaining frames are from the actual incoming video stream.

The Media Streaming Subsystem comprises at least one switch connecting the CDCS to the MSS. It will be apparent to those skilled in the art that the switch may be an optical switch or alternatively, an Ethernet switch, Ultra SCSI switch, or SATA I/II switch may be used. The switch can facilitate selection and communication between the CDCS, multiple storage units, and the Media Streaming Subsystem. A System Controller may be managing the interoperation of one or more media streaming servers contained in the MSS and one or more storage devices. Additionally, a Web Server Subsystem may be presenting the interface to the user via a web site. It will be understood by those skilled in the art that the Web Server Subsystem and the System Controller may reside on the same physical unit or may be distributed over several servers. The user inputs may be received through the Web Server Subsystem and processed by the Media Streaming Subsystem in order to retrieve the various data files requested by the system user and pass them on to the gateway means to forward to the requesting system user.

### Storage Means

The system comprises a storage means for storing selected compressed digital data and permitting stored compressed digital data to be retrieved. The storage means can comprise a plurality of storage devices scaled to store large amounts of data from the encoded data streams. It will be apparent to those skilled in the art that the size of the storage unit is dependant on the number of files that need to be stored on a given system. The storage means can comprise of a RAID array of large capacity hard disk drives (HDD), for example. The amount of storage capacity required is proportional to the amount of data that has to be stored. For example, 11 terabytes of storage capacity may be used to store twenty-four hours of programming over a span of one week, produced for fifty channels for MPEG-2 video at standard definition. Alternately, HDTV will typically require at least four times the data storage, for example.

The storage means may also contain one or more Data-on-Demand (DOD) servers to deliver content such as Video-on-Demand, Audio-on-Demand, Television-on-Demand, etc. In one embodiment, the DOD server delivers bit streams from the disk, or array of disks, at a constant bit rate. The DOD server can assure that once a stream request is accepted, the stream is delivered at the specified bitrate until the stream ends or the server is given another command, such as to stop, rewind, fast forward, etc.

In one embodiment of the present invention, one week of television programming produced for a particular geographic region may be stored in the storage means. It will be appreciated by those skilled in the art that the design of the CDCS and the storage means may be scalable in order to allow larger storage capacities and greater traffic in the system.

Delivered data streams can be independent in that they can each be stopped and started independently. Furthermore, these delivered bit streams may each contain different content (i.e. each being a different movie) or a plurality of delivered streams can be from the same content stream, such as a plurality of video streams containing video data from the same movie. Furthermore, the data streams from the same content need not be synchronized so that more than one viewer can be watching the same movie simultaneously, although one user started the movie at a different time from the other.

There are two general models used for DOD server systems. One is a “pull” model, in which a system user can request information from the DOD server, which then responds to these requests. In such “pull” type systems, there are inherently-present controls to ensure that data is received on time and in a proper sequence even in the event of bit errors, since the receiving device can re-request information or hold a request until a previous request has been properly received. This “pull” model may, for example, support an IP Unicast environment using Real-Time Transport Protocols (RTP) or Real-Time Streaming Protocols (RTSP).

The other model for DOD servers is the “push” model, in which the DOD server “pushes” the video stream out with no dynamic flow control or error recovery protocol. In this “push” model of stream delivery, the server delivers data streams from the array of disks. The DOD server's requesting client must assume that once a stream request is accepted, the stream is delivered until the stream ends or the server is told to stop. This “push” model may, for example, support an IP Multicast environment using RTP or RTSP.

While the system is capable of both push and pull models, typically the pull model will be used to enable users with more features such as rewinding, fast-forwarding, chapter/scene changing, pausing, etc. The push model will more typically be used when a provider wishes to restrict such features.

### User Computing Devices (UCD)

The system further comprises one or more User Computing Devices (UCDs) connected to the broadband communication network for receiving selected compressed digital data streams and subsequently decompressing these streams and presenting them to the system user. The UCDs are capable of decoding the compressed data and outputting the information visually and/or audibly or sending the decoded signal to another device such as a television and/or audio receiver or speakers. The UCD may also be capable of collecting channel information, displaying an electronic program guide, and can be used to change channels. The UCD can provide substantially seamless integration with other IP-based services such as web surfing, Voice-Over-IP, IP video phone, instant messaging, and eCommerce, for example. In one embodiment, a UCD can issue Internet Group Management Protocol (IGMP) join and leave messages and can send membership reports to the Media Streaming Subsystem and/or the System Controller. When a system user changes a channel, the UCD can notify the system that it does not need the old multicast stream and needs to join a new group. It then receives the new stream, decodes the stream, and either outputs the signal, or sends the decoded signal to another output device. The UCD can be firmware or software upgradeable to allow for seamless revisions of codecs, the GUI and other applications on the UCD or system. Further, some UCDs may be allowed to store content, for example recording multiple signals of broadcast television for time-shifting purposes; typically referred to as a digital recording device (DVR). The system according to the present invention can comprise DVR capabilities through use of a hard drive in the UCD. Since the system can be using a low bitrate video codec, the DVR functionality may not require encoding of the signals, just stream capture to the hard drive. Since the signals are typically encrypted, each DVR feed can be protected. For ADSL deployments, the number of streams that can be captured is dependent on the bandwidth available to the UCD. For example in most cases the available bandwidth can facilitate recording of 3-4 video channels per DSL line. In cable systems, for example, the entire multicast bandwidth may be available to each UCD, thereby making the hard drive or the Ethernet connection limit the recordable feeds to between 30 and 500 video channels, for example.

At the UCD, the payload data on all the program slots dedicated to the data program such as the audio and video data can be decompressed back to its original resolution minus any losses due to compression, and converted to a signal format suitable for output, such as television, computer monitor or other display device. For example, if the display device is a TV that is an NTSC, PAL or SECAM TV, an appropriate analog signal format such as an NTSC signal modulated onto RF channel 3 or 4 is generated. If the UCD is coupled to the video or S-video and audio inputs of the TV that bypass the tuner, the video and audio data can be converted into analog composite video and audio signals. If the TV conforms to either a high-definition or digital standard, then the video and audio data may be sent from DV-I, 1394, or any other appropriate digital interface. A Set-Top Box (STB) or other UCD may also output digital audio signals through standard interfaces such as S/PDIF. In some embodiments, each STB can have a wireless input unit such as a wireless keyboard or a remote control. As an example, one can provide extra features if an intelligent remote or keyboard is used. Each of these intelligent remotes can have a bidirectional radio frequency or infrared link to the STB or other UCD, and each of these remotes can have a miniature display thereon upon which digital data associated with a program may be displayed either with or without simultaneous display of the data on the TV. Messages can be displayed on the mini-display on the remote only or both on the mini-display on the remote and on the TV or other output device also.

In one embodiment, the present invention comprises a Set-Top Box (STB) that is able to decode transmitted compressed data and output a signal to a display device, such as a television and/or audio receiver. The STB can include a polling/interrupt protocol enabling IP communication in the STB with a multi-processor coupled implementation of a Digital Signal Processor (DSP) and a Central Processing Unit (CPU). This coupled implementation of a DSP and CPU can provide for an increase in productivity of the DSP, as the operating system and other applications such as an Internet browser can reside on the CPU. The coupled implementation can overcome numerous limitations of having a DSP alone by allowing increased functionality through a larger instruction set, and a more flexible environment with a wide variety of software applications. The STB can be connected to a high-speed, quality-of-service (QoS) enabled communication network providing access to the gateway. The polling/interrupt protocol enables unique communication between a DSP and an Interprocess Communication/Remote Procedure Call (IPC/RPC) stack.

The STB can decode the audio/video stream that is pulled from the gateway, parse out programming and media information from the stream, and produce a graphics overlay to display this programming and media information, which can be layered over a video stream. Further, all software and codec information that resides on the STB can be fully upgradeable and not hardwired into the board. The STB can provide seamless integration with other IP-based services, for example web surfing, Voice-Over-IP, IP video phone, instant messaging, eCommerce, and the like. The STB may also connect to a home computer network which can provide extended media services such as applications, photos, audio, and video interaction. The home computer could also run the entire STB software for those instances where it is desirable to have a computer as the UCD.

The STB CPU can communicate with the DSP via a polling/interrupt protocol. In one embodiment, the present invention uses the RPC/IPC as the base communication layer upon which the following subsections communicate between the host CPU and the multimedia DSP; namely the video, audio, graphics, and codec API. The Video API is responsible for getting a video display buffer and adding to a display queue. Likewise, the Audio API is responsible for getting an audio buffer and adding to an output queue. The Graphics API is responsible for rendering Picture in Picture (PIP), Electronic Programming Guide (EPG) or any other image data on top of the video signal. Finally, the Codec API is where the video and audio codecs are communicated with to encode/decode multimedia data.

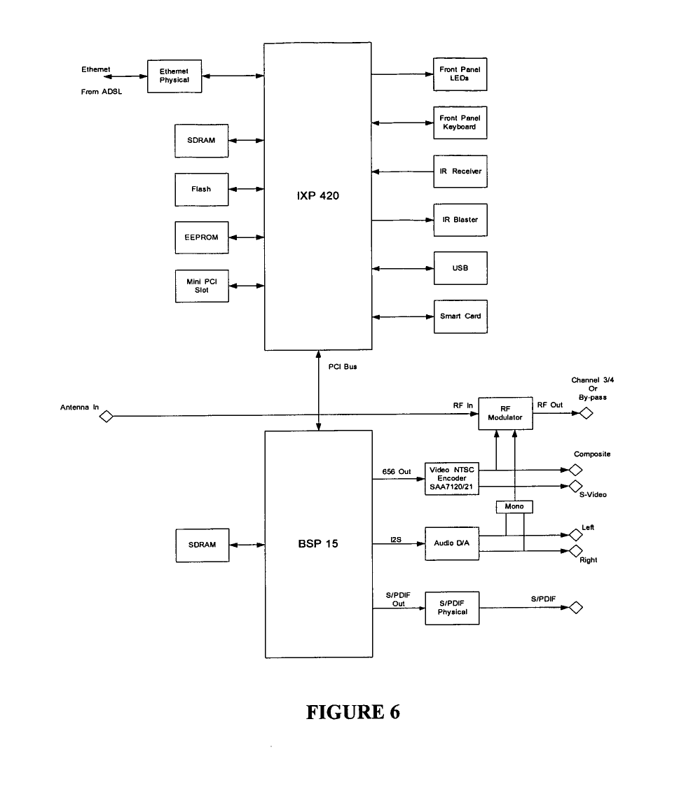

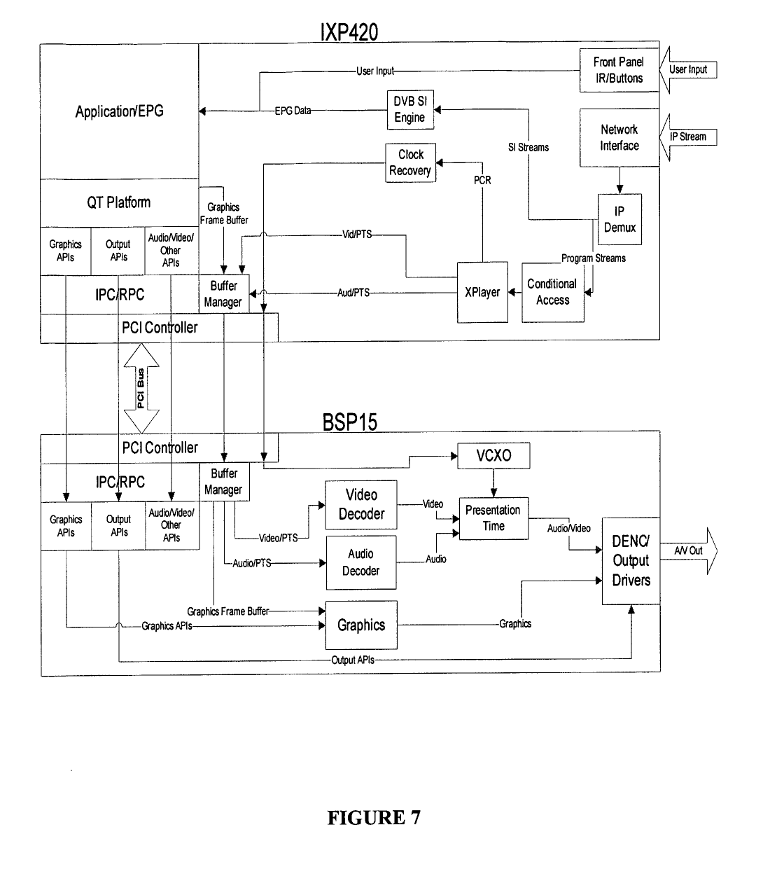

In one embodiment of the present invention, FIG. 6 illustrates the set-top box indicating the various functions of each of the chip components of the STB. The IXP 600 is the general processor (CPU) responsible for the user interaction, graphical interface and the input. The BSP 610 is the special multimedia DSP processor responsible for video decoding and output. FIG. 7 illustrates the software functionality of the IXP, the general purpose processor and the BSP, the multimedia processor according to one embodiment of the present invention. FIGS. 6 and 7 illustrate that the BSP 610 is responsible for the video decoding and signal display, while the IXP 600 ensures that the audio and video are synchronized. The IXP is further responsible for the user interface, user interaction and channel selections. In one embodiment, the BSP can have a RF modulator in order to allow for channel pass-through.

In one embodiment, when a STB is used, upon power up the STB may initialize and configure its hardware and software systems. Upon initialization, the STB may display through a television the initial graphical user interface (GUI) allowing the system user to select programs and services. User identification can be loaded automatically and after the user authentication is completed, the STB may display the system's main GUI page. The system user can select the category of programming desired such as news, sports or movies. The system user may input selections within a particular subcategory, such as the subcategory of football under the general category of sports. The system user may use a television remote control device to navigate a virtual keyboard displayed on the television set and enter his or her selections. The system user can confirm his or her selection of a particular program selecting and activating the selected program. The system user can select various functions such as pause, rewind, or fast forward applied to the program being displayed on the television set. The system user can select particular functions by using the input device, such as a television remote control or wireless keyboard, to select the special functions available by navigating and selecting the desired function from an On-Screen Display (OSD). The system user may terminate the display of the particular program by selecting the stop function or home icon on a title bar of the GUI. The selection of the stop/home button can allow the system user to return to previous GUIs where one may enter a new category, sub-categories and program selection. It will be apparent to those skilled in the art that other GUIs and program selection means may be used to implement the program selection function.

In one embodiment, the GUI can allow the system user to select the programs and functions one desires by navigating through an intuitively straight-forward program display interface. For example, the system user may select a desired channel from a list of available channels in a first step. The GUI opens multiple new windows, displaying the available program selections broadcast over that channel during a given time period. It will be apparent to those skilled in the art that the GUI may be customized by the user service level agreement and that access to certain programs may be restricted. This may be accomplished by either not displaying the programs and channels to which access is restricted or not allowing the selection of such programs and channels. Selection of certain programs or channels may also be restricted by the system user for purposes such as parental control.

Each customer's premises may allow signals and data from other sources besides a single broadband source such as a DSL line or a cable modem to be supplied to the peripherals coupled to the gateway by a LAN. Typical gateways can have satellite transceivers, cable modems, DSL modems, an interface to the public service telephone network and tuners for conventional TV antennas. All these circuits can be interfaced to one or more local area networks through an IP packetization and routing process and one or more network interface cards.

### System Controller

The System Controller can provide management and control of the system components and services provided by the system. The System Controller can be designed so that all independent processes are capable of running on the same hardware or being moved to different hardware as the system load increases. Typically, however, there can be many separate components each performing specific functions. The System Controller can be comprised of an Encoder Element Manager (EEM), a Data-on-Demand Element Manager (DOD-EM), a Set-Top Box Element Manager (STB-EM), a Network Element Manager (NEM), Digital Video Broadcasting Service Information (DVB-SI), a Billing System (BS) interface, an Electronic Program Guide (EPG) server, a Conditional Access System (CAS), and a Master Control Application. As would be readily understood, many tasks can be performed by one particular device or manager depending on the design of the System Controller.

The Encoder Element Manager (EEM) can provide provisioning and status of the encoders. It can also configure the cross-connect layer and the switch/router to allow a proper source to match the desired service. It can also handle redundant or back control of the encoders. If an encoder becomes non-functional or needs to be taken offline, the EEM may bring a new encoder online to replace the failing encoder. The functions of the EEM may include such tasks as starting and stopping capturing, channel management issues such as smooth swapping or transition from one channel to another in case of hardwire channel failure and other such management issues. Furthermore, the EEM may perform such functions as turning channels on and off, or controlling the format, the resolution and the speed of the encoding process. In one embodiment, the EEM may be a separate dedicated CPU.

The Data-on-Demand Element Manager (DOD-EM) can provide the provisioning and status of the Data-on-Demand Server. It can monitor content, and facilitate communication between the DOD server and other elements in the system.

The Set-Top Box Element Manager (STB-EM) can contain a database of all STBs in the network, and in one embodiment, the STB-EM database can comprise the UserID, IP/MAC address, serial number and can contain all services that each STB is authorized to receive. The STB-EM can also provide initial configuration information to each STB. The STB-EM can be able to communicate with the EPG server, the CAS and also the VOD server, through the Subscriber Management System, thereby enabling it to provide valid data to the STB. The CAS interface can be controlled by the STB-EM which can allow IP/MAC addresses to access the content on the system. The STB-EM may also include a separate STB server that can control applications, software and maintenance of STBs. The STB server can interact with the STBs to update the firmware and/or software for the codecs on the STBs, as well as providing patches and revisions to all software on the STBs, including the Graphical User Interface (GUI) from which system users can access the system. Further, the STB Server may include a web server and personalized user interface for system users, which can be accessed by the STBs. Using such an interface, system users may access a plurality of dynamic and/or personalized services provided through the system.

The Network Element Manager (NEM) can provide provisioning and status of all network devices such as routers, switches, etc. A database can be maintained on the NEM for the status of all network elements in order to help in fault tolerance and fault isolation. The NEM can provide for the allocation of network resources, such as bandwidth, IP addresses, connectivity, etc.

System Information and Announcement Services can also be provided through the System Controller. Using the Digital Video Broadcasting Service Information (DVB-SI) standard, metadata regarding services can accompany broadcast signals and assist the UCDs and system users in navigating through the array of services offered. The DVB-SI can be generated by the System Controller to enable UCDs to understand how to locate and access services on the network.

A Billing System Interface may also reside on the System Controller to interface with an external billing system. Transactions can be based on the Common Billing Interface specification. The billing system interface can distribute and collect transaction information from various components of the System Controller.

The Electronic Program Guide (EPG) server can act as a bridge between a guide information provider and the System Information generation process. The EPG server can periodically collect guide information from a service provider. The information can be packaged and mapped onto the actual channel line up defined in the local network. Once the information is packaged for a particular network, the data can be passed to the System Information generator for insertion into the network. The EPG can be linked to a CAS interface and a BS interface to provide customized EPG data based on the service level of each system user.

A Conditional Access System (CAS) can provide for the encryption of services provided by the system. The CAS can provide Entitlement Management Messages (EMM) and Entitlement Control Messages (ECM) to control access to the services. The EMMs can be targeted to a specific decoder or user device, whereas the ECMs can be specific to a program or service. An EMM can provide general information about the subscriber and the status of the subscription and can be sent with an ECM. The ECM can be a data unit that can contain the key for decrypting a transmitted program. The CAS can be capable of preventing someone from joining a broadcast stream that they have not paid for. Even if someone was able to join that broadcast stream, the media encryption routines (DRM) can render the streams unusable for those that have not paid for them

A Master Control Application can be responsible for control of services in the network. The Master Control Application can maintain a database of the service definitions, which can be based on the information provided via the BS interface. The service definitions can be used as the basis for the generation of the system information and to establish which services will require the CAS. The Master Control Application can provide a user interface for controlling and monitoring the overall system. The user interface can show a graphical representation of the elements and connectivity of the network elements, as well as providing monitoring of alarm indications and event logging.

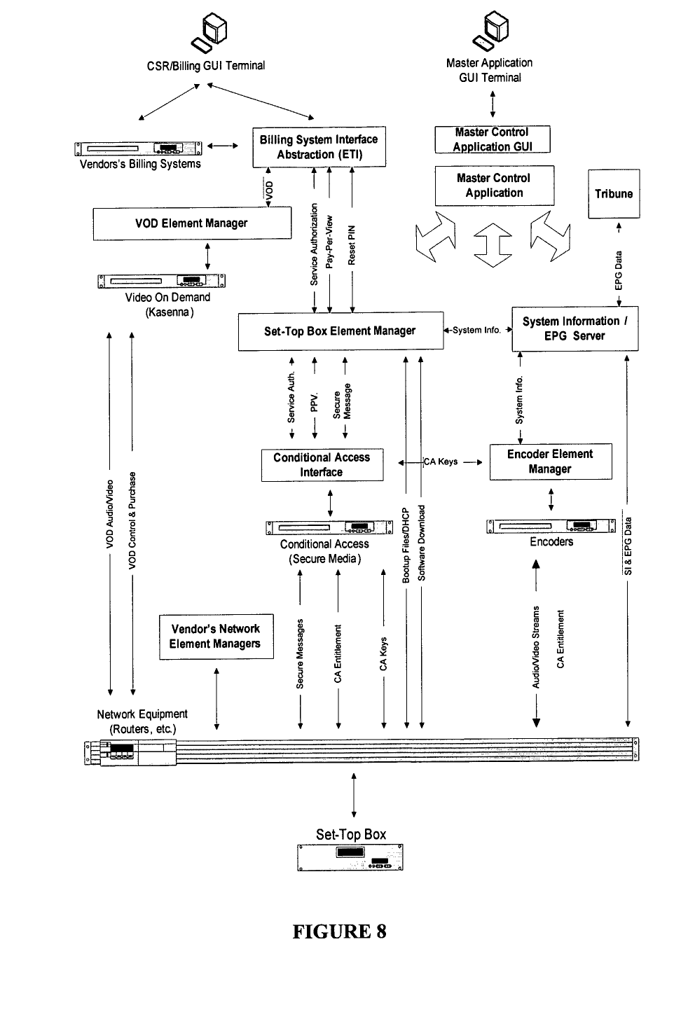

In one embodiment of the present invention, FIG. 8 illustrates the overall system components and the interconnectivity between the components integrated into the system controller. FIG. 8 illustrates the communication flow and interactions of the various modules associated with this embodiment of the present invention, wherein this figure emphasizes the communication flow associated with an IP broadcast video head-end. In particular there are substantially two symbiotic functions of a subscriber-based system, namely the delivery of the desired information and the billing system, wherein these two functions are linked via the Conditional Access System (CAS). The CAS acts as a layer between the data, for example the video stream, EPG, and the billing system and as a result typically data flows are directed through the CAS.

In one embodiment of the present invention, the Subscriber Management System (SMS) can be a subcomponent of the Billing System, and can keep track of system users and their IDs in the system. When the Master Control Application instantiates a change to the provisioning information for an individual on the system via the SMS/Billing System, communication can be transmitted to the CAS, the EPG and VOD server to update the access privileges of that particular system user.

### Gateway Means

The system can include a gateway means for receiving compressed digital data from the Media Streaming Subsystem and preparing the data for transmission over a broadband communication network to a system user sending a request. The wide band of frequencies provided by a broadband communication network can allow for multiplexing of data that may be concurrently transmitted on many different frequencies or channels within the band. Broadband communication can allow for the transmission of more data in a given time, thus providing a high data transmission rate. The actual width of a broadband communication channel may vary from technology to technology. The gateway means allows for seamless integration of various telecommunications services for delivering video/voice/data unified services. The gateway means may be designed to accomplish wire-speed IP routing and provide a single service access point for multiple telecom services and connections to the existing traditional service-specific networks and access networks.

In one embodiment, the backbone carrying the broadband communication may be based on a fast Ethernet architecture. Alternatively, the broadband network service may be based on an Asynchronous Digital Subscriber Line (ADSL) system or Hybrid Fibre-Coax (HFC).

The gateway means can comprise both a core network and an access network. The core network can be both IP and Ethernet-based, can support high bandwidths, and can be scalable. The core network can be a backbone of Ethernet routers that support the Internet Group Management Protocol (IGMP) on the edge with a high-end fibre transport system. IGMP can provide a standard for multicasting and can be used to establish host memberships in particular multicast groups on a single network. The mechanisms of the protocol can allow a host to inform its local router, using Host Membership Reports, that it wants to receive messages addressed to a specific multicast group. The core network can connect to an access network via a layer three/four switch or router. A broadband switch, bridge or hub may be used to control and subdivide the traffic over the broadband connection into smaller bandwidth channels. For example, a 2 GB broadband channel may be divided into 24 or any other number of 10 or 100 MBit/s Ethernet links. The data storage and processing capabilities of the content creation and processing unit enables the system to provide time-shifted television services, wherein programming for N number of channels may be available on demand to a user regardless of their location within the network. The switch can distribute traffic from the high capacity backbone to a lower capacity access network. The switches can have efficient switching and support a high quality of service (QoS).

The access network can be one of many common technologies used to provide broadband access to a client-end. This can include Hybrid Fibre-Coax (HFC), Digital Subscriber Lines (DSL), Integrated Services Digital Networks (ISDN) such as Broadband ISDN, wireless, etc. In one embodiment, a DSL Access Multiplexer (DSLAM) may be used to bridge the IP network to the copper lines running into a subscriber's home. The DSLAM can support IGMP and QoS to support the video and high-speed data services of the system. The DSLAM can link to the edge switch via Gigabit Ethernet, DS3 (T-3 Carrier) Ethernet over a Synchronous Optical Network (SONET), or the like. The DSLAM can deliver the desired multicast stream to the appropriate subscriber through IGMP. Multicast traffic can typically only be sent to ports requesting to be a member of a particular multicast group. The DSLAM can monitor IGMP messages being sent from each UCD and can forward these messages to the edge router only when necessary. It can forward all queries, join reports and membership reports and can forward leave messages only as needed. The DSLAM can track membership of each port and can forward multicasts only to those ports requesting membership in a particular group.

The access network can connect to a home network containing multiple PCs, STBs, and other User Computing Devices. In one embodiment, a DSL modem can act as a bridge forwarding all requests to the DSLAM and forwarding data from the DSLAM back to the UCD. The Ethernet port on the modem can be full duplex, so that data uploads will not interfere with downstream multicast traffic. The modem can be connected to an Ethernet switch/router, which will allow each UCD to have its own connection.

In one embodiment, wideband Internet access IP packets can be encapsulated into Ethernet packets by gateway or cable/DSL modem and addressed to the User Computing Device. The network interface card of a UCD can receive the Ethernet packets, strips off the Ethernet headers and pass the IP packets up through the IP protocol stack to the application that requested them. If the application has IP packets to send back out to the Internet, the packets are generated in the application and sent down to the network interface card (NIC). The NIC encapsulates them into Ethernet packets and transmits them to the cable/DSL or other modem. The modem then takes these packets and transmits them to Media Streaming Subsystem via the gateway means. For example, if the modem is a cable modem and the upstream data path is hybrid fibre-coax, then the IP packets are disassembled and interleaved, Trellis encoded, code division multiplexed onto whatever logical channels are assigned to cable modem and QAM modulated onto the RF carrier being used to frequency division multiplex the upstream data from the downstream data. The Media Streaming Subsystem can receive the upstream signals from the cable modem and recover the IP packets in a conventional manner and routes the IP packets out to the Internet over a data path to a server or router coupled to the Internet.

Telephony can work similarly. The gateway means is typically coupled to a known T3 interface circuitry that is responsible for gathering bytes from T3 timeslots assigned to a particular conversation and packetizing them into IP packets addressed to, for example, a particular UCD. These IP packets are culled out of the stream of packets and output in the output stream devoted to the channel and program slot to which it has been assigned for a particular session and then transmitted downstream. The IP packets are recovered and encapsulated into Ethernet or other LAN packets at the modem by a modem and then transmitted to the designated UCD. Signals generated by UCD for transmission back to the Media Streaming Subsystem would follow the reverse sequence of events using whatever form of multiplexing and modulation that is conventional for the upstream path. If the upstream data path is shared by all the customer premises for both upstream and downstream data transmission, then some form of upstream multiplexing such as SCDMA, CDMA, FDMA or TDMA is used to separate the upstream data from the various customers. In addition, the upstream data typically must be multiplexed to keep it separate from the downstream data. Typically, FDMA is used for that purpose but other forms of multiplexing could also be used. If the downstream and upstream data paths are DSL lines, there may be no need for multiplexing to separate the data from different customers since customers each get their own DSL line, and conventional DSL multiplexing to separate upstream from downstream data can be used.

A DSL modem in the gateway means can be devoted to each DSL line to a system user. Each DSL modem at the gateway means can have a conventional structure. Each DSL modem at the gateway means and the system user's premises can function to send and receive information on three channels: a separate analog channel for Plain Old Telephone Service (POTS); a high speed wideband downstream channel based upon T1 specifications in increments of 1.536 Mbps up to 6.144 Mbps, for example referred to herein as the wideband channel; and, a bidirectional channel provided in increments of 64 Kbps up to 640 Kbps for example referred to herein as the bidirectional channel and which can carry requests and upstream data. DSL service is described in Horak & Miller, Communications Systems and Networks, Voice, Data and Broadband Technologies (1997) M&T Books, Foster City, Calif.

The system can be capable of passing closed caption data as found on line 21 of the Vertical Blanking Interval (VBI) of NTSC video signals. The encoders can parse out the VBI and the Extended Announcement System (EAS) information and send it along with timestamp information to the broadcast stream. This data can be reinserted into the output of the UCD. If the UCD is a STB, for example, the STB can capture the data and send it to the graphics output chip to be rendered in normal fashion for the television. The format of the data can conform to CEA-608-B. The system can be capable of utilizing other VBI data other than closed caption data, such as through the North American Broadcast Teletext System (NABTS) and the Neilson rating service data known as AMOL.

The system can be capable of supporting standard copy protection on all analog and digital outputs at the UCD. This capability can enable the system to restrict the subscriber from copying the output. Further, the system can be capable of encrypting and/or scrambling all content during the encoding process.

This system can be capable of supporting the Emergency Alert System as required by the FCC.

The system can be capable of providing backup or redundant components or sub-systems throughout the Compressed Data Creation Subsystem, Media Streaming Subsystem and gateway means. Switch-over to backup systems can be under both automatic and manual control. Manual control can be used to provide maintenance and repair of components and subsystems.

The system can be capable of a pay-per-view service by granting access to system users that are pre-authorized via the Conditional Access System to decrypt or descramble video/audio programming during a specified interval. In addition, the system can be capable of an impulse pay-per-view service by granting access to system users requesting authorization via the UCD to decrypt or descramble video/audio programming. The impulse pay-per-view service can also be subject to authorization via the CAS. Both pay-per-view services can be continuously transmitted or streamed throughout the network only during the specified interval that an event is active. The pay-per-view service can be contrasted with, for example, the DOD service where data is requested by a system user and is sent only to that system user and not broadcast throughout the network.

The system can be capable of delivering non-encrypted or encrypted audio-only programming, and restricting access, if encrypted, to only those subscribers pre-authorized via the CAS. This service can be continuously transmitted or streamed throughout the network using a “push” model, such as RTP using IP multicast, for example. The service may be accompanied by data that provides information about the current audio program, such as title track, data, or still images that are updated at some interval.

The system can be capable of delivering multiple audio streams for video/audio programming services that require second language audio.

### Channel Zapping Means

In one embodiment, a requirement for a broadcast media over IP solution is the ability to cope with a large number of channel changes or zapping as system users surf channels. Since the channel switching is actually occurring in the network there can be latency and performance issues that can possibly cause the channel changing experience to be too long for the subscriber. A typical UCD can change channels and display video in less than a second. In a very large network where there are a large number of subscribers sending channel change requests into the network, the edge switches may become overloaded, thus causing the channel change to extend beyond the one second mark. Also, each channel change time can be dependent on the load in the network. If the load is high and the switches are loaded, then the channel change can be long and if the network is lightly loaded then the channel change time can be short. In order to provide a typical system user experience, the network components, loading, and turnaround time typically are designed to allow for all channel changes to be less than one second. The UCD can use IGMP join/leave messages in order to connect or change channels. The switch can wrap all the IGMP information into the stream, whereby the DSLAM can conduct the stream join/leave for the UCD. Each channel change request can typically only be made aware to the DSLAM, so central office equipment for example will typically not be flooded with channel change requests. It may be possible that a non subscribing UCD may connect to a signal not allowed in the provisioning information; however, that signal will not have decryption keys, which is a task of the CAS, thereby rending the stolen signal useless.

### EXAMPLE

### Video Encoding System

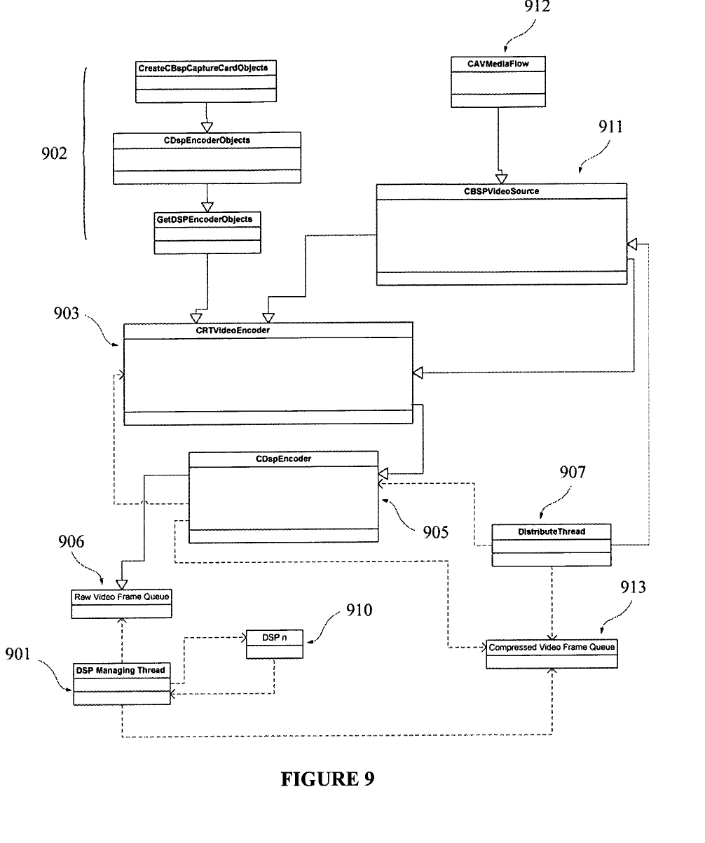

FIG. 9 illustrates the program flow control of the video encoding system or the encoding/transcoding system according to one embodiment of the present invention. The video encoding system comprises a plurality of DSP based units 910 each of which can be started, initialized and controlled by a DSP Managing Thread 901 which can create and control one or more Real Time Video Encoders 903 which in turn can create and control one or more DSP Encoders 905 which control the encoding for each DSP based unit. A Real Time Video Encoder can control each DSP based unit which can encode video in real time. The Distribute Thread 907 controls the flow of video frames from the Raw Video Frame Queue 906 which need to be encoded by the DSP Encoder 905 and also controls the flow of encoded video frames in the Compressed Video Frame Queue 913. Video Media Flow 912 and Video Source 911 program flow components control the source of frames for the Real Time Video Encoder 903. The program flow components 902 can control the hardware and software object initialization. It is understood, that a DSP based unit can comprise two or more DSPs.

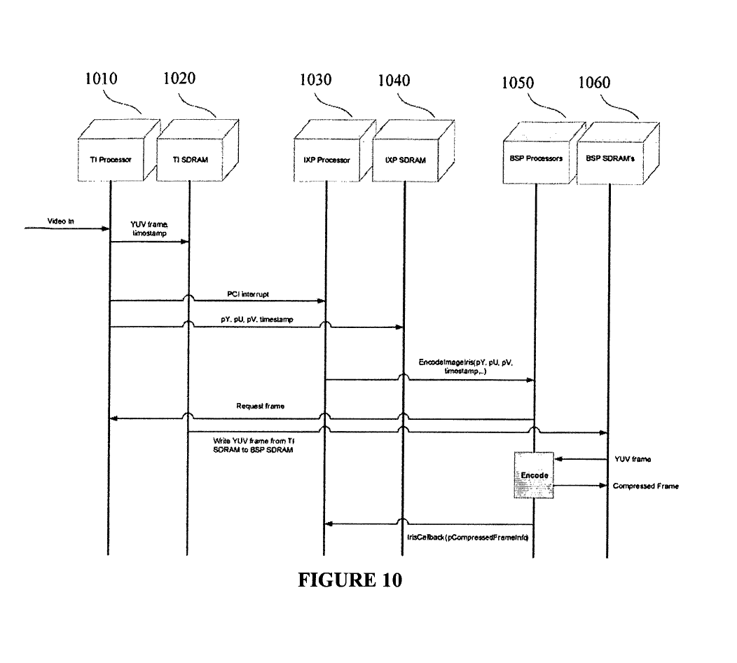

FIG. 10 illustrates a video encoder method according to an embodiment of the present invention. This method can utilize, for example, a TI™ DSP 1010 which can capture video frames into SDRAM 1020 of the TI™ DSP, can generate a PCI interrupt invoking the IXP 1030, and can transfer the address of the frame to the IXP SDRAM 1040 via DMA (direct memory access). The IXP then calls the program flow control described in FIG. 9, for example, to invoke one or more BSP processors 1050 and passes pointers to the Y, U, and V components to the BSP SDRAM 1060. It is understood that a multiprocessor architecture of the video encoder can be abstracted in the program flow control. The BSP can request the frame from the TI™ DSP card via a PCI interface and the TI™ DSP can transmit the frame to the BSP SDRAM via DMA. The BSP encodes the frame and notifies the IXP via a call-back function that can provide a pointer to the compressed frame information, which can reside in the BSP SDRAM. Subsequently, the IXP copies the compressed frame data into its SDRAM which can be formatted, for example, into RTP packets for subsequent transmission to the MSS or saved on a storage device.

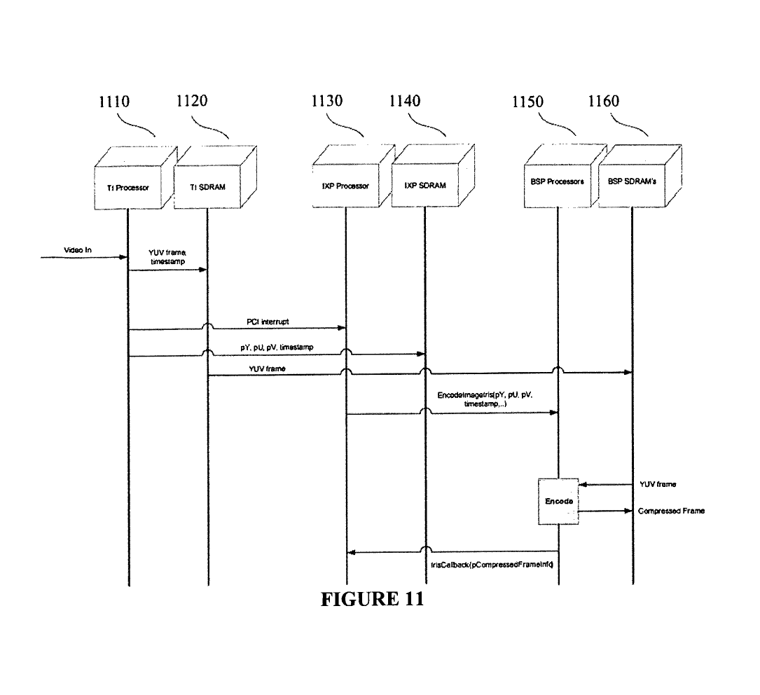

FIG. 11 illustrates a video encoder method according to another embodiment of the present invention. This method is similar to the one illustrated in FIG. 10. The TI™ DSP 1110, utilizing its SDRAM 1120, and can additionally assign the video sequence for distributed processing by one or more BSP processors 1150. This allows the TI™ DSP to transfer frames to the BSP SDRAM 1160 via DMA. The rest of the processing of the video signal is similar and the IXP processor 1130 with its IXP SDRAM 1140, when receiving an interrupt from the TI™ DSP, can call the program flow control software to invoke the encoding process.

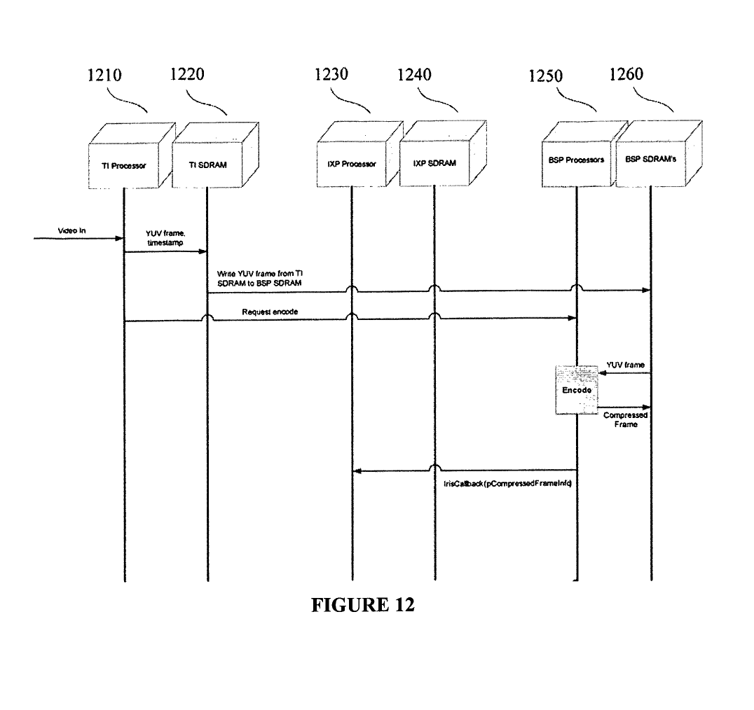

FIG. 12 illustrates a video encoder method according to another embodiment of the present invention. In this method one or more BSP processors 1250 can autonomously encode a stream of video data without mediation by the IXP processor 1230 or its IXP SDRAM 1240. The IXP processor initiates one or more BSP processors 1250 and can forward frame data into the BSPs SDRAM 1260 for processing by the encoding process. Similar to the method illustrated in FIG. 11, the TI™ DSP 1210 can assign video data for processing by one or more BSPs and can directly transfer video frames into the BSPs SDRAM 1220 via DMA. It is understood, that the encoder parameters can be controlled by an IXP processor 1230 and that such parameters can be requested by each of the one or more BSP processors 1250 via, for example, RPC or IPC.

### EXAMPLE

### The Set Top Box API

In one embodiment of the present invention, the application programming interface (API) for the set-top box is provided by the following. There are essentially five separate APIs integrated into this embodiment of the set-top box, namely the Video API, the Audio API, the Graphics API, the RPC/IPC API and the Codec API.

Section 1: Video API

(a) InitVideo(

unsigned int uiWidthParam,
unsigned int uiHeightParam,
double dFramerateParam)

Description:

This routine requires 3 input parameters to initialize the video display driver,
including the video width and height, as well as the video play back rate. It can
allocate the video handle for video display.

Parameters:

| | |
|---|---|
| unsigned int uiWidthParam; | the video width |
| unsigned int uiHeightParam; | the video height |
| double dFramerateParam; | the frame rate |

(b) DeInitVideo(

VIDEOVAR *pvideovarParam)

Description:

This routine can de-initialize the video display handler. It can take the video
display handle pointer as the input.

Parameter:

| | |
|---|---|
| VIDEOVAR *pvideovarParam; | the video display handle pointer |

(c) GetVideoBufferPtr(

VIDEOVAR *pvideovarParam,
unsigned chat **ppucFrameParam,
int iBlockParam)

Description:

This routine can get a video display buffer from the video driver.

Parameters:

| VIDEOVAR *pvideovarParam; | the video display driver handle |
|---|---|
| unsigned chat **ppucFrameParam; | the returned buffer pointer from the display |
| driver | |
| int iBlockParam; | the flag if the function should be blocked |

until a

buffer is returned.

(d) AddVideoBuffer(

VIDEOVAR *pvideovarParam,
unsigned char *pucFrameParam,
unsigned long long ullTimeStampParam,
int iBlockParam)

Description:

This routine can put the filled video display buffer to the video driver for display.

Parameters:

| VIDEOVAR *pvideovarParam; | the pointer to the video display |
|---|---|
| handle | |
| unsigned char *pucFrameParam; | the pointer to the filled video buffer |
| unsigned long long ullTimeStampParam; | the time stamp that the video is |
| displayed | |
| int iBlockParam; | the flag if the function should be |

blocked

until a buffer is returned.

Section 2: Audio API

(a) InitAudio(

unsigned int uiPCMBufferSize,
unsigned int uiNumChannels,
unsigned int uiSamperate,
unsigned int uiSampleSize,
BufferFreeCallback userCallback,
void * firstBuffer)

Description:

This routine requires 6 input parameters to initialize the audio playback drive,
including the audio buffer size, audio channels, sampling rate per channel and
bits per sample. It can allocate the audio handle for audio playback.

Parameters:

| unsigned int uiPCMBufferSize; | the entire buffer size allocated for the audio |
|---|---|
| driver | |
| unsigned int uiNumChannels; | the channels number of the audio stream |
| unsigned int uiSamperate; | the sampling rate of the audio stream |
| unsigned int uiSamperate; | the bit depth of each audio sample |
| BufferFreeCallback userCallback; | the user specified call back function |
| void * firstBuffer; | the pointer to the audio buffer |

(b) DeInitAudio(

AUDIOVAR *paudiovarParam)

Description:

This routine can de-initialize the audio playback handler. It takes the audio
playback handle pointer as the input.

Parameter:

| | |
|---|---|
| AUDIOVAR *paudiovarParam; | the audio driver handle |

(c) GetAudioBuffer(

AUDIOVAR *paudiovar,
int wait)

Description:

This routine can get an audio playback buffer from the audio driver.

Parameters:

| | |
|---|---|
| AUDIOVAR *paudiovar; | the audio driver handle |
| int wait; | the flag if the function should wait until a |
| buffer is | |

returned.

(d) PutAudioBuffer(

AUDIOVAR *paudiovar,
unsigned char *pucAudio)

Description:

This routine can put a filled audio buffer to the audio driver for playback.

Parameter:

| | |
|---|---|
| AUDIOVAR *paudiovar; | the audio driver handle |
| unsigned char *pucAudio; | the pointer to audio buffer |

Section 3: Graphics API

(a) gfxInit(

tGfxStatus *pStatus)

Description:

This routine can use internally defined constant parameters to initialize the
graphic driver. It can allocate the graphic handle for graphic display.

Parameter:

| | |
|---|---|
| tGfxStatus *pStatus; | the pointer to the return status |

(b) gfcDeInit(

GRAPICSVAR *pgraphicsvarparam)

Description:

This routine can de-initialize the graphics display handler. It can take the
graphics handle pointer as the input.

Parameter:

| | |
|---|---|
| GRAPICSVAR *pgraphicsvarparam; | the graphics driver handle |

(c) gfxRefreshBuffer(

GRAPHICVAR *pgraphicsvarParam,
const tGfxSquare *pGfxSquare)

Description:

This routine can refresh the graphic display at the beginning to avoid graphic

hangs.
Parameter:

| | |
|---|---|
| GRAPHICVAR *pgraphicsvarParam; | the graphic driver handle |
| const tGfxSquare *pGfxSquare; | the pointer to the graphics square |

structure

(d) setFrameBufferUpdate( )
Description:

This routine can update the new graphic once it is available.

Section 4: RPC/IPC API

(a) InitPSIVIntHandler(

tBspMemoryMap *pmmap,
GRAPHICSVAR *pgraphics,
VIDEOVAE *pvideo,
AUDIOVAR *paudio)

Description:

This routine needs the video, audio and graphics handlers as the
input parameters. It can initialize the RPC/IPC communication. It
can allocate the RPC/IPC handle for the RPC/IPC communication.

Parameter:

| tBspMemoryMap *pmmap; | the global memory for the BSP |
|---|---|
| | memory |
| map | |
| | structure |
| GRAPHICSVAR *pgraphics; | the graphic driver handle |
| VIDEOVAE *pvideo; | the video driver handle |
| AUDIOVAR *paudio; | the audio driver handle |

(b) ServeRPC( )
Description:

This routine can responds to any IPC message.

Section 5: Codec API

(a) InitializePSIV(

volatile _uncached_int * pioSema0,
volatile _uncached_int * pioMsgSize0,
volatile _uncached_unsigned char * pcBuffer0,
volatile _uncached_int * pioSema1,
volatile _uncached_int * pioMsgSize1,
volatile _uncached_unsigned char * pcBuffer1,
int Length,
int * width,
int * height)

Description:

This routine can decode the first video frame and can initialize the IRIS decoder

engine.
Parameter:

| volatile _uncached_int * pioSema0; | the pointer of the semaphore |
|---|---|
| of the | |
| | video buffer0 |
| volatile _uncached_int * pioMsgSize0; | the pointer of the actual bytes |
| size of | |
| | the video buffer0 |
| volatile _uncached_unsigned char * pcBuffer0; | the pointer to the video |
| buffer0 | |
| volatile _uncached_int * pioSema1; | the pointer of the semaphore |
| of the | |
| | video buffer 1 |
| volatile _uncached_int * pioMsgSize1; | pointer of actual byte size of |
| the video | |
| | buffer 1 |
| volatile _uncached_unsigned char * pcBuffer1; | the pointer to the video |
| buffer1 | |
| int Length; | the maximum size of the |
| video buffer | |
| int * width; | the pointer to the width to be |
| returned | |
| int * height; | the pointer to the height to be |
| returned | |

(b) DecodeLoopPSIV(

tPSIVIntData* pPSIVIntData,
void (*pFunc)(chat * pcParam),
char *pcFuncParam,
double dFrameRateParam)

Description:

This routine can decode all the frames in a loop.

Parameter:

| tPSIVIntData* pPSIVIntData; | the pointer to the IPC handle |
|---|---|
| void (*pFunc)(chat * pcParam); | the callback function pointer |
| char *pcFuncParam; | the parameter passed into the callback |
| function | |
| double dFrameRateParam; | the frame rate |

The embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A system for providing a plurality of system users IP-centric, multi-channel, time-shifted and real-time telecommunications services including live television, television-on-demand, video-on-demand, streaming audio, audio-on-demand, said system comprising:
a) a compressed data creation subsystem for receiving multiple data signal streams each having one of several industry standard communication formats, and for converting the incoming data signal streams into compressed digital data, said compressed digital data being created using a predetermined compression scheme;
b) a storage means for storing selected compressed digital data and permitting stored compressed digital data to be retrieved therefrom;
c) a media streaming subsystem for receiving and forwarding streams of compressed digital data, said media streaming subsystem being responsive to a user request and operative to forward a selected stream of compressed digital data from either the compressed data creation subsystem or the storage means to a gateway means;
d) a gateway means for receiving said compressed digital data from the media streaming subsystem and preparing said compressed digital data for transmission over a broadband communication network to a user sending the user request; and
e) a user computing device, connected to the broadband communication network, for receiving the selected stream of compressed digital data and the user computing device decompressing and presenting said selected stream of compressed digital to the system user.

2. The system according to claim 1, wherein the compressed data creation subsystem comprises two or more encoding devices for converting the incoming data signal streams into compressed digital data.

3. The system according to claim 2, wherein each encoding device comprises one or more digital signal processors.

4. The system according to claim 3, wherein the one or more digital signal processors are operatively coupled to a central processing unit in the encoding device and the central processing unit manages the flow of predetermined portions of the incoming data signal streams to the one or more digital signal processors operatively coupled thereto.

5. The system according to claim 2, wherein the each of the two or more encoding devices is dynamically assigned portions of the incoming data signal streams.

6. The system according to claim 2, wherein each of the two or more encoding devices includes a means for adjusting complexity and bitrate associated with the compressed digital data resulting from the step of converting the incoming data signal streams.

7. The system according to claim 2, wherein the compressed data creation subsystem further comprises one or more backup encoding devices.

8. The system according to claim 2, wherein the compressed data creation subsystem and the user computing device each include one or more firmware upgradable devices, thereby providing a means for dynamically changing an encoding scheme associated with the system.

9. The system according to claim 1, wherein the compressed data creation subsystem further generates an I-frame channel representative for each of said incoming data signal streams, thereby providing a means for changing the selected stream of selected digital data for subsequent forwarding to the user computing device.

10. The system according to claim 1, wherein the user computing device is a set-top box, said set-top box comprising a multi-processor configuration.

11. The system according to claim 9, wherein the multi-processor configuration comprises a digital signal processor and a central processing unit, wherein IP communication between the multi-processor configuration can be enabled using a polling/interrupt protocol.

12. The system according to claim 11, wherein the polling/interrupt protocol is configured using RPC/IPC as the communication layer providing a means for each of a video API, audio API, graphics API and a codec API to communicate between the digital signal processor and the central processing unit.

13. The system according to claim 9, wherein the central processing unit provides a means for system user interaction with the set-top box, generation of a graphical interface for presentation to a user and for receiving the selected stream of digital data, and wherein the digital signal processor provides a means for decoding said selected stream of digital data.

14. A method for providing a plurality of system user IP-centric, multi-channel, time-shifted and real-time telecommunications services including live television, television-on-demand, video-on-demand, streaming audio, audio-on-demand, said method comprising:
a) receiving multiple incoming data signal streams each having one of several industry standard communication formats and converting the incoming data signal streams into compressed digital data using a predetermined compression scheme;
b) storing selected compressed digital data;
c) selecting user requested compressed digital data from the compressed digital data and the selected compressed digital data in response to a user request and forwarding the user requested compressed digital data to a gateway means;
d) receiving the user requested compressed digital data in the gateway means and preparing the user requested compressed digital data for transmission over a broadband communication network to a user computing device sending the user request; and
e) receiving the user requested compressed digital data by the user computing device and decompressing and displaying the user requested compressed digital data by means of the user computing device.

15. The method according to claim 12, wherein the step of converting the incoming data signal streams comprises the step of dynamically allocating an encoding device selected from two or more encoding devices to convert a particular portion of the incoming data signal streams.

16. The method according to claim 15, wherein each encoding device comprises one or more digital signal processors operatively coupled to a central processing unit, the central processing unit managing the flow of predetermined portions of the incoming data signal streams to the one or more digital signal processors operatively coupled thereto.

17. The method according to claim 15, wherein each of the two or more encoding devices independently adjust bitrate and complexity of converting the particular portion of the incoming data signal streams associated therewith.

18. The method according to claim 17, wherein the adjustment of the bitrate and complexity of converting the particular portion of the incoming data signal streams is based on a predetermined set of parameters.

19. The method according to claim 14, further comprising the step of generating a representative I-frame channel for each of said incoming data signal streams.
